(19) United States
(12) Patent Application Publication
(10) Pub. No.: US 2024/0173884 A1
(43) Pub. Date: May 30, 2024

(54) LOG SPLITTER AND METHOD OF USE

(71) Applicants: Mathew Kopec, Kasilof, AK (US); Macen Kopec, Kasilof, AK (US); Kaden Kopec, Kasilof, AK (US)

(72) Inventors: Mathew Kopec, Kasilof, AK (US); Macen Kopec, Kasilof, AK (US); Kaden Kopec, Kasilof, AK (US)

(21) Appl. No.: 18/519,357

(22) Filed: Nov. 27, 2023

Related U.S. Application Data
(60) Provisional application No. 63/428,614, filed on Nov. 29, 2022.

(51) Int. Cl. B27L 7/00; E02F 3/14

(52) U.S. Cl. CPC B27L 7/00; E02F 3/142

(57) ABSTRACT

A log splitter uses a bucket on an excavator vehicle like an excavator, backhoe, skid steer, tractor, front end loader, etc., having an arm with the bucket rotating relative thereto. A wedge is connected to the arm, and logs may be placed between the wedge and the bucket with the bucket then rotated towards the wedge to split the logs against the wedge. When not in use, the bucket may be used for its normal operation substantially, if not completely, without interference of the wedge.

### CLAIM OF PRIORITY

This application claims the benefit of U.S. Provisional Application No. 63/428,614 filed Nov. 29, 2022, which is incorporated herein by reference in its entirety.

### FIELD OF THE INVENTION

The present invention relates to a log splitter, and more particularly to a log splitter which has a bucket of an excavator type machine used as a portion of the log splitting device.

### BACKGROUND OF RELATED ART

Splitting firewood for home heating is a labor intensive activity for which a number of solutions have been developed. While manual labor can employ a wedge and a sledge hammer to drive the wedge through a log to split it, or an axe to drive directly through a log, some more advanced solutions involve a dedicated piece of equipment having a hydraulic piston which pushes a log directly into a splitting wedge in a linear manner to split the log. The hydraulic piston of these devices moves directly towards the wedge to split the logs in these prior art devices. See U.S. Pat. No. 7,134,464 for a representative prior art log splitter. While effective, a dedicated piece of equipment is required using this technology.

Accordingly, a need exists for using an excavator type piece of equipment such as an excavator, skid steer, front end loader, backhoe, or other excavator type equipment to be able to function in its excavation roles as well as periodically split logs.

### SUMMARY OF THE INVENTION

It is an object of many embodiments of the present invention to provide an improved device which functions as a log splitter and uses a bucket of an excavator type machine as a component thereof.

It is another object of many embodiments of the present invention to use the bucket of an excavator in combination with a wedge connected to an arm or other portion of the excavator to split wood.

Accordingly, in accordance with a presently preferred embodiment of the present invention, an excavator type machine such as a front end loader, backhoe, skid steer, excavator or other vehicle having a rotating bucket supported by an arm extending from the vehicle is equipped with a wedge at another location spaced from the bucket, such as along the arm so that a log may be positioned between the bucket and the wedge and then the bucket rotated toward the wedge to thereby apply a force to split the log.

The present invention has many advantages over prior art log splitters. First, the wedge is relatively small and easy to install, particularly when installing on a common backhoe or excavator boom or arm. Second, the wedge attachment does not encumber the excavator from performing other tasks, like dirt moving, etc.

At a minimum, every other device known by the applicant to be used with excavators requires the removal of the bucket and replacement with a piece of equipment that is designed to use the hydraulics of the device to operate a dedicated piece of equipment to split logs, many of which are similar to the design of U.S. Pat. No. 7,134,464 in function. The applicant's solution is particularly cost efficient, easy to install, unencumbering and highly effective.

### BRIEF DESCRIPTION OF THE DRAWINGS

The particular features and advantages of the invention as well as other objects will become apparent from the following description taken in connection with the accompanying drawings in which:

FIG. 1 is a perspective view of a log splitter equipped excavator of a presently preferred embodiment of the present invention with a detailed view of an end of the boom arm and bucket;

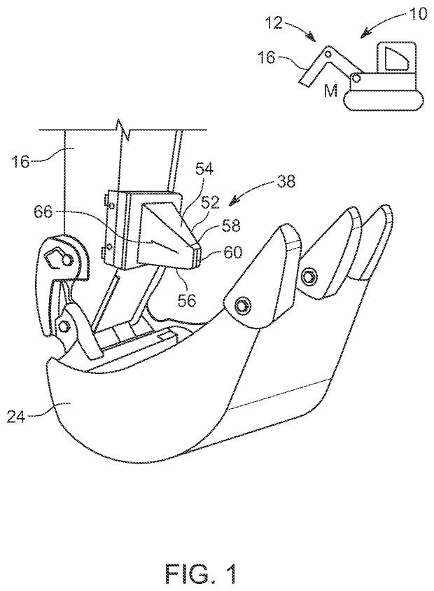

FIG. 2 is perspective view of the detailed of the end of the boom and bucket shown in FIG. 1 with a log being inserted for splitting;

FIG. 3 is a perspective view similar to FIG. 2 with the log contacting the wedge and the bucket; and

FIG. 4 is a perspective view similar to FIGS. 2 and 3 with the log being split.

### DETAILED DESCRIPTION OF THE PREFERRED EMBODIMENTS

An excavator 10 has a boom 12 with at least one arm 14,16, and/or others. An arm 16 connects to a coupler 22 and/or a bucket 24 at an end 18 at a pivot 20. The bucket 24 rotates relative to the arm 16 under the direction of an operator, normally in cab 26.

There are many ways that buckets 24 can rotate relative to arm 16 as is known in the art. In the illustrated embodiment, a piston 28 is driven relative to cylinder 30. Piston 28 connects to bucket 24 such as at connection 32 so that as the piston extends from cylinder 30, the teeth 34 at end 36 of the bucket 24 rotate toward the arm 16 as illustrated. If the piston 28 moves back into the cylinder 30, the teeth 34 and end 36 of bucket 24 move away from the arm 16 as illustrated.

A wedge 38 may be attached to the excavator 10, such as along the arm 16 or other location of the excavator 10. The wedge 38 may have a base plate 40 and opposing flanges 42,44 which may receive the arm 16 therebetween and connect such as by bolting with bolts 46 through bores 48, be welded, and/or otherwise connect the wedge 38 to the arm 16 or other excavator location. By locating the wedge 38 on the arm 16, the wedge 38 preferably do not significantly, if at all, interfere with the operation of the bucket 24 when the bucket 24 is performing excavating tasks.

The wedge 38 may be simple in construction such as a single flat plate or slant 50, or it may be a multisided structure, such as opposing slants 50,52, and/or a faceted structure such as having another slant or face 54,56, etc. The wedge 38 may have a sharp edge 58 or a blunter end face 60.

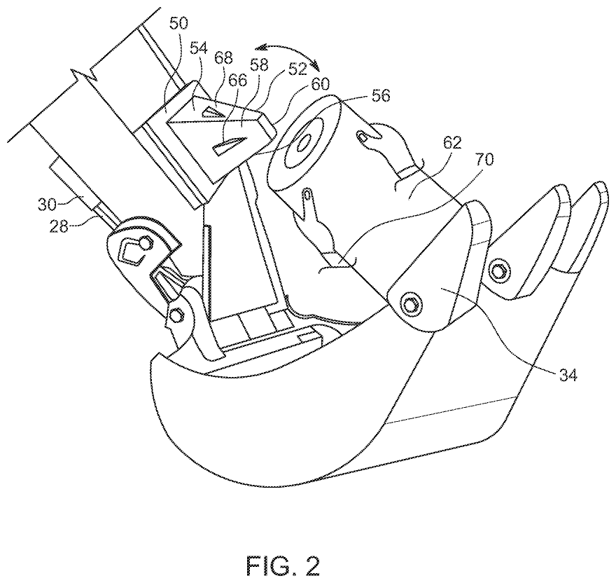

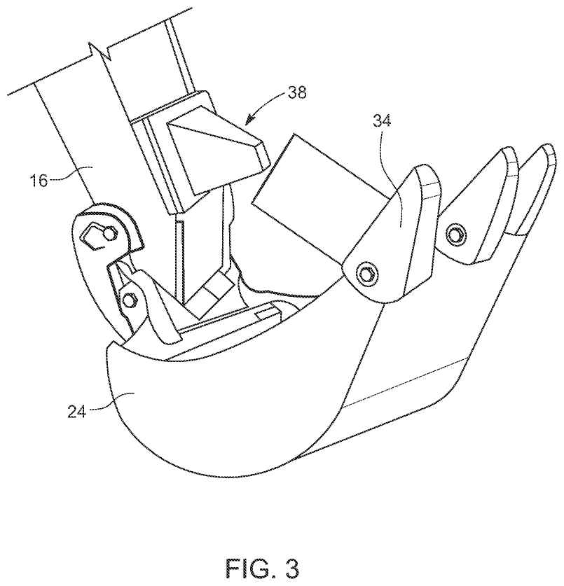

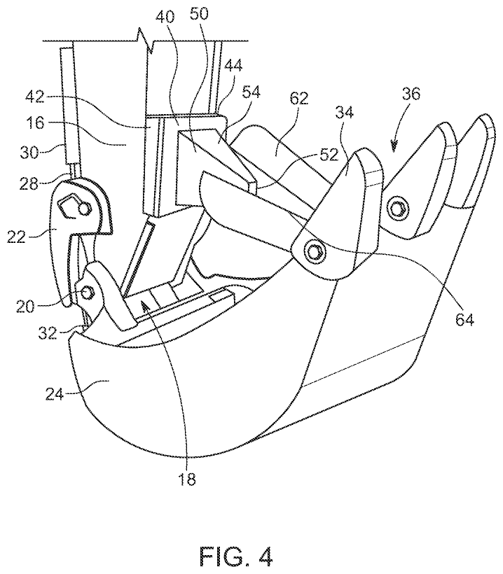

In operation, a log 62 is positioned between a portion of the bucket 24 and the wedge 38 as seen in FIG. 2 and the bucket 24 rotated toward the wedge so that the log 62 contacts both the wedge 38 and the bucket 24 as seen in FIG. 3. The bucket 24 is then continued to move towards the wedge 38 and/or arm 16 so that the force of the bucket 24 acting through the log 62 on the wedge 38 drives the log 62 along the wedge 38 to split the log 62 as seen in FIG. 4.

Wedges 38 may be manufactured as is known in the art, but ¼ inch plate for the base plate 40, flanges 42, 44 and faces 50,52,54, and/or 56 possibly in a faceted arrangement, such as a pyramid meeting at one of an edge 58 and/or a blunter face 60 may be implemented for various embodiments. Wedge 38 preferably extends along a plane of rotation of the bucket 24 (the plane of rotation being perpendicular to the rotation axis of the bucket 24 through the pivot 20 for at least some embodiments. The wedge 38 also preferably extends cantileveredly away from arm 16.

Wedges 38 may be somewhat universal in shape or tailored for specific boom arms 16 of various manufacturers. It will be understood that facets 50,52 would cooperate to split the log 62 as shown, while facets 54,56 may simultaneously cooperate to split a log 62 substantially perpendicularly to split log 62 along split 64. Blades 66 and/or 68 may be employed to split log 62 in additional directions during the operation as well, in a substantially simultaneous manner.

Bucket 24 may be an OEM bucket of any manufacturer, many of which are available in the marketplace today.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A log splitter comprising:
an excavator type vehicle having an arm connected to a bucket, said bucket rotatable relative to the arm;
a wedge connected to the arm of the excavator type vehicle in a plane of rotation of the bucket;
whereby a log is placed between the wedge and the bucket and movement of the bucket toward the wedge splits the log.

2. The log splitter of claim 1 wherein the wedge is located toward an end of the arm connected to the bucket.

3. The log splitter of claim 2 wherein the arm is pivotably connected to the bucket towards the end of the arm.

4. The log splitter of claim 1 wherein the excavator type vehicle is one of an excavator, backhoe, front end loader, skid steer, and tractor having the arm extending away from the vehicle.

5. The log splitter of claim 1 wherein the wedge has opposing faces.

6. The log splitter of claim 5 wherein the opposing faces are symmetrically disposed relative to one another.

7. The log splitter of claim of 5 wherein the wedge has two sets of opposing faces.

8. The log splitter of claim 7 wherein the sets of opposing faces form a pyramid shape.

9. The log splitter of claim of 5 wherein the opposing faces extend from a base plate and the base plate is secured to the arm.

10. The log splitter of claim of 9 wherein the base plate has opposing flanges receiving the arm therebetween.

11. The log splitter of claim 10 wherein the opposing flanges are substantially parallel to one another.

12. The log splitter of claim 1 wherein the arm and bucket are pivotably connected at a pivot.

13. The log splitter of claim 12 further comprising a hydraulic cylinder having a piston selectively movable relative thereto, whereby movement of the piston moves the bucket relative to the arm about the pivot.

14. The log splitter of claim 13 wherein the piston is operably coupled to the bucket and the cylinder is connected to the arm.

15. The log splitter of claim 1 wherein the wedge is one of bolted and welded to the arm.

16. The log splitter of claim 1 wherein the wedge cantileveredly extends away from arm into a plane of rotation of the bucket.

17. A method of splitting logs comprising the steps of:
a) providing an excavator type vehicle having an arm connected to a bucket, said bucket rotatable relative to the arm;
b) connecting a wedge to the arm of the excavator type vehicle in a plane of rotation of the bucket; and
c) placing a log between the wedge and the bucket to contact both the wedge and the bucket and rotating the bucket towards the wedge to thereby split the log against the wedge.

18. The method of claim 17 wherein the excavator type vehicle is one of an excavator, backhoe, front end loader, skid steer, and tractor having the arm extending away from the vehicle.

19. The method of claim 18 wherein the bucket is pivotably connected to the arm.
